(19) United States
(12) Patent Application Publication
(10) Pub. No.: US 2023/0096349 A1
(43) Pub. Date: Mar. 30, 2023

(54) Method of Fabricating Cathode Film Layer of Lithium Ion Battery by Plasma Spraying

(71) Applicant: Institute of Nuclear Energy Research, Atomic Energy Council, Executive Yuan, R.O.C., Taoyuan (TW)

(72) Inventors: Chun-Laing Chang, Taoyuan (TW); Chun-Huang Tsai, Taoyuan (TW); Chang-Shiang Yang, Taipei (TW); Cheng-Yun Fu, Taoyuan (TW); Min-Chuan Wang, Taoyuan (TW); Tien-Hsiang Hsueh, Taoyuan (TW)

(21) Appl. No.: 17/485,620

(22) Filed: Sep. 27, 2021

(51) Int. Cl. H01M 4/04; H01M 4/505; H01M 4/525; H01M 4/62

(52) U.S. Cl. CPC H01M 4/0471; H01M 4/505; H01M 4/525; H01M 4/625

(57) ABSTRACT

A method is provided for fabricating a film layer. A cathode film layer of lithium ion batteries is fabricated through atmospheric plasma spraying (APS) without using polymer adhesive. The ratio of its active substance can even reach 100%. Moreover, the cathode film layer fabricated by APS obtains pores, where, with the coordination of a liquid electrolyte, electrolyte penetration paths are provided to significantly increase the area of reaction. Hence, the effective thickness of the film layer is relatively thick and the capacity of battery is increased. As an example, the thickness of a film layer of lithium cobalt oxide fabricated accordingly reaches more than 100 microns; and its maximum electric capacity per unit area reaches 6 milliampere-hours per square centimeter (mAh/cm²). Thus, the performance of the follow-on solid-state lithium-ion battery is improved and its high-volume manufacturing cost is reduced.

### TECHNICAL FIELD OF THE INVENTION

The present invention relates to fabricating a cathode film layer; more particularly, to fabricating a cathode film layer by atmospheric plasma spraying (APS) without polymer adhesive, where a cathode film layer fabricated by APS obtains high conductivity and its effective thickness is relatively thick; and the capacity of battery is increased accordingly.

### DESCRIPTION OF THE RELATED ARTS

Regarding the fabrication of cathode film layer for lithium ion battery, screen printing is the mainstream technology, where cathode materials are aggregated and adhered onto the surface of a metal substrate by adding a polymer adhesive. The polymer adhesive is an inactive substance that cannot undergo electrochemical reaction of migrating lithium ions in and out; therefore, the capacitance of cathode is limited. Besides, the cathode film layer made through screen printing is affected by the polymer adhesive, where the conductivity of the cathode is limited. After the cathode film reaches an effective thickness, the electric capacity of the lithium battery cannot increase following the increase of the film thickness. This is the limitation of the capacitance of the cathode film currently sold commercially. Take the material of lithium cobalt oxide (LiCoO₂) as an example. Its electric capacity per unit area is about 2-3 milliampere-hours per square centimeter (mAh/cm²) and it cannot be further improved. Hence, the prior art does not fulfill all users' requests on actual use.

### SUMMARY OF THE INVENTION

The main purpose of the present invention is to fabricate a cathode film layer by APS without polymer adhesive, where the ratio of its active substance can even reach 100 percent.

Another purpose of the present invention is to obtains pores in the cathode film layer, where, with the coordination of a liquid electrolyte, electrolyte penetration paths are provided to significantly increase the area of reaction; and, hence, its effective thickness is relatively thick and the capacity of battery is increased accordingly.

Another purpose of the present invention is to fabricate a film layer of lithium cobalt oxide by the plasma-spraying accordingly with its thickness reaching more than 100 μm and its maximum electric capacity per unit area reaching 6 mAh/cm².

To achieve the above purposes, the present invention is a method of fabricating a cathode film layer of lithium ion battery by plasma spraying, comprising steps of: (a) substrate pretreatment: applying vacuum coating to a metal substrate, where an oxidation-resisting metal layer is formed on the metal substrate; (b) spheroidizing granulation: processing spheroidizing granulation with an active material of lithium and at least one non-lithium metal and an inactive conductive material to obtain a mass block, where the mass block has a size of 10˜100 μm; and (c) plasma spraying: putting the mass block into a plasma flame to process APS, where the APS uses a gas flow of argon and nitrogen uniformly mixed to obtain an atmospheric plasma flame; with a spraying power of 10˜50 kilo-watts (kw), the mass block is heated to a molten sate or a semi-molten sate; and a film is thus formed on the oxidation-resisting metal layer of the metal substrate to obtain a porous cathode film layer. Accordingly, a novel method of fabricating a cathode film layer by spraying lithium ions through plasma is obtained.

### BRIEF DESCRIPTION OF THE DRAWINGS

The present invention will be better understood from the following detailed description of the preferred embodiment according to the present invention, taken in conjunction with the accompanying drawings, in which

FIG. 1 is the flow view showing the preferred embodiment according to the present invention; and

FIG. 2 is the structural view showing the lithium-ion cathode film layer.

### Description of the Preferred Embodiment

The following description of the preferred embodiment is provided to understand the features and the structures of the present invention.

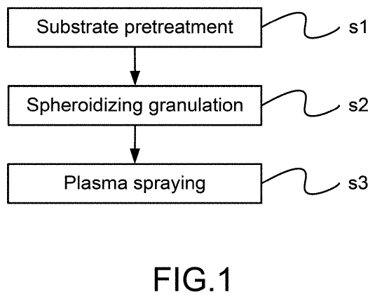

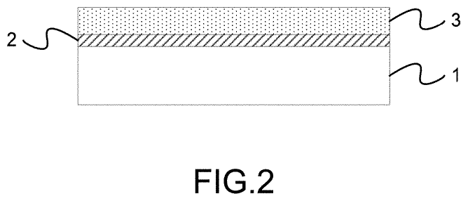

Please refer to FIG. 1 and FIG. 2, which are a flow view showing a preferred embodiment according to the present invention; and a structural view showing a lithium-ion cathode film layer. As shown in the figures, the present invention is a method of fabricating a cathode film layer of lithium ion battery by plasma spraying, comprising the following steps:

(a) Substrate pretreatment s1: A metal substrate 1 is obtained to be applied with vacuum coating, where an oxidation-resisting metal layer 2 is formed on the metal substrate 1.

(b) Spheroidizing granulation s2: Spheroidizing granulation is processed with an active material of lithium and at least one non-lithium metal and an inactive conductive material to form a mass block, where the mass block has a size of 10˜100 microns (μ).

(c) Plasma spraying s3: The mass block is put into a plasma flame to process atmospheric plasma spraying (APS), where the APS uses a gas flow of argon and nitrogen uniformly mixed to generate an atmospheric plasma flame; with a spraying power of 10˜50 kilo-watts (kw), the mass block is heated to a molten sate or a semi-molten sate; and, finally, a film is thus formed on the oxidation-resisting metal layer 2 of the metal substrate 1 for forming a porous cathode film layer 3.

Thus, a novel method of fabricating a cathode film layer by spraying lithium ions through plasma is obtained.

In a state-of-use, the metal substrate 1 is made of iron, chromium, aluminum, or an alloy thereof, and has a thickness of 20˜400 μm.

In a state-of-use, the oxidation-resisting metal layer 2 is made of gold, silver, or platinum.

In a state-of-use, the active material is lithium cobalt oxide (LiCoO₂) or lithium nickel cobalt manganese oxide (Li(NiMnCo)O₂).

In a state-of-use, the inactive conductive material is graphite or a conductive material.

In a state-of-use, the thickness of the porous cathode film layer 3 is more than 100 μm.

Hence, the present invention has the following features:

1. The present invention fabricates a cathode film layer by using an atmospheric plasma without polymer adhesive. The ratio of its active substance can even reach 100 percent. Moreover, the cathode film layer fabricated by plasma-spraying obtains pores, where, with the coordination of a liquid electrolyte, electrolyte penetration paths are provided to significantly increase the area of reaction. Thus, the effective thickness of the film layer is relatively thick and the capacity of battery is increased accordingly. The thickness of a film layer of lithium cobalt oxide fabricated accordingly by the plasma-spraying reaches more than 100 μm, and its maximum electric capacity per unit area reaches 6 milliampere-hours per square centimeter (mAh/cm²). Hence, the performance of the follow-on solid-state lithium-ion battery is improved and its high-volume manufacturing cost is reduced.

2. Regarding the coating speed, the unique rapid sintering ability of APS is used for fabricating a cathode film layer of solid-state lithium-ion battery. The coating speed can reach more than 1 μm per minute, where, as compared to the coating speed of 1 nanometer per minute through vacuum coating, rapid production is obtained. Moreover, the oxide film layer fabricated through the present invention can form a correct crystalline structure without heat treatment.

To sum up, the present invention is a method of fabricating a cathode film layer of lithium ion battery by plasma spraying, where a cathode film layer fabricated by APS obtains high conductivity and its effective thickness is relatively thick; the capacity of battery is increased accordingly with a maximum electric capacity per unit area reaching 6 milliampere-hours per square centimeter (mAh/cm²); and, thus, the performance of the follow-on solid-state lithium-ion battery is improved with the high-volume manufacturing cost reduced.

The preferred embodiment herein disclosed is not intended to unnecessarily limit the scope of the invention. Therefore, simple modifications or variations belonging to the equivalent of the scope of the claims and the instructions disclosed herein for a patent are all within the scope of the present invention.

What is claimed is:

1. A method of fabricating a cathode film layer of lithium ion battery by plasma spraying, comprising steps of:
(a) substrate pretreatment: applying vacuum coating to a metal substrate,
wherein an oxidation-resisting metal layer is obtained on said metal substrate;
(b) spheroidizing granulation: processing spheroidizing granulation with an active material of lithium and at least one non-lithium metal and an inactive conductive material to obtain a mass block,
wherein said mass block has a size of 10˜100 microns (μ); and
(c) plasma spraying: disposing said mass block into a plasma flame to process atmospheric plasma spraying (APS),
wherein said APS uses a gas flow of argon and nitrogen uniformly mixed to obtain an atmospheric plasma flame; with a spraying power of 10˜50 kilo-watts (kw), said mass block is heated to a state selected from a group consisting of a molten sate and a semi-molten sate; and a film is thus formed on said oxidation-resisting metal layer of said metal substrate to obtain a porous cathode film layer.

2. The method according to claim 1,
wherein said metal substrate is made of a material selected from a group consisting of iron, chromium, aluminum, and an alloy thereof.

3. The method according to claim 1,
wherein the thickness of said metal substrate is 20-400 μm.

4. The method according to claim 1,
wherein said oxidation-resisting metal layer is made of a material selected from a group consisting of gold, silver, and platinum.

5. The method according to claim 1,
wherein said active material is selected from a group consisting of lithium cobalt oxide (LiCoO₂) and lithium nickel cobalt manganese oxide (Li(NiMnCo)O₂).

6. The method according to claim 1,
wherein said inactive conductive material is selected from a group consisting of graphite and a conductive material.

7. The method according to claim 1,
wherein said metal substrate is processed through APS at a heating temperature of 50˜500 degrees Celsius (° C.).

8. The method according to claim 1,
wherein the thickness of said porous cathode film layer is more than 100 μm.
